(19) United States
(12) Patent Application Publication
(10) Pub. No.: US 2021/0359549 A1
(43) Pub. Date: Nov. 18, 2021

(54) INDUCTION CHARGING FOR A PORTABLE ELECTRONIC DEVICE WITH A GRIP ATTACHMENT

(71) Applicant: PopSockets LLC, Boulder, CO (US)

(72) Inventors: Altan Nahum, Boulder, CO (US); Judd Nutting, Boulder, CO (US)

(21) Appl. No.: 17/050,097

(22) PCT Filed: Feb. 7, 2020
(86) PCT No.: PCT/US2020/017335

§ 371 Date: Oct. 23, 2020

Related U.S. Application Data
(60) Provisional application No. 62/802,586, filed on Feb. 7, 2019.

(51) Int. Cl. H02J 50/12; H02J 50/00

(52) U.S. Cl. CPC H02J 50/12; H02J 50/005

(57) ABSTRACT

Induction charging devices and methods are disclosed for a portable electronic device that has a reception coil coupled to a power source and an outwardly projecting attachment mounted thereon. In some implementations, the devices include a housing having a wall with an outwardly facing charging surface and a recess sized to receive the attachment with the portable electronic device disposed on the charging surface. In some implementations, devices can include an attachment device coupled to a rear of a housing that can releasably secure to a portion of a vehicle and a mount coupled to a front of the housing. A charging assembly within the housing can include a transmission coil disposed so that with the recess or mount receiving the attachment therein, the transmission and reception coils are sufficiently aligned to charge the power source of the portable electronic device.

### PRIORITY CLAIM

This application claims priority to prior U.S. provisional patent application Ser. No. 62/802,586 filed Feb. 7, 2019, entitled, “Induction Charging for a Portable Electronic Device with a Grip Attachment.” The entire content of the aforementioned application is hereby expressly incorporated by reference.

This application for Letters Patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office files/records, but otherwise reserves all rights.

### FIELD OF THE DISCLOSURE

The present disclosure generally relates to chargers for electronic devices and, more particularly, to wireless chargers for portable electronic devices.

### BACKGROUND

Wireless charging for portable electronic devices, such as smart phones, has become increasingly popular. In use, the electronic device is placed on a charging station and an electromagnetic field transfers energy from the charging station to the electronic device through electromagnetic induction. The energy is then used by the electronic device to charge a battery.

Portable electronic devices can also be housed in protective covers or cases, such as in order to protect the device from damage. Such cases may include expandable devices and/or decorative buttons, which may display logos, decals, symbols, or other artistic renderings.

### SUMMARY

In accordance with one aspect, an induction charging apparatus for a portable electronic device is disclosed. The portable electronic device has a reception coil that is coupled to a power source and has an outwardly projecting attachment mounted thereon. The charging apparatus includes a housing defining an interior and having a wall with an outwardly facing charging surface configured to receive the portable electronic device thereon for charging the power source thereof. A recess in the wall is sized to receive the attachment therein with the portable electronic device disposed on the charging surface. A charging assembly is disposed within the housing and includes a transmission coil having an annular configuration extending around the recess such that, with the attachment received therein, the transmission coil is sufficiently aligned with the reception coil to thereby charge the power source of the portable electronic device.

According to some forms, the induction charging apparatus can include one or more of the following aspects: the annular configuration of the transmission coil can include a main surface of the transmission coil extending generally parallel with the outwardly facing charging surface; the annular configuration of the transmission coil can include can include a cylindrical configuration extending away from the wall; the recess can have a circular shaped cross-section in a plane parallel to the charging surface; the recess can include a bottom wall and a depth of the recess between the charging surface and the bottom wall can be sized to receive the attachment in the recess with the attachment spaced from the bottom wall; the transmission coil can be spaced from the charging surface (e.g., about 1 mm); an interior diameter of the transmission coil can be greater than, e.g., about 40 mm; the transmission coil can be mounted to an interior surface of the wall; or the charging surface further can include a tacky portion.

According to some forms, the housing can include a base with a bottom wall and an upstanding sidewall, the wall can include an outwardly projecting flange that is configured to rest on the upstanding sidewall and is movable with respect to the base to access the interior of the housing, and the transmission coil can be received within a housing portion coupled to the wall. According to further forms, the charging assembly can include an electrical cord having a plug at a distal end coupled to the base and a port coupled to the wall and configured to receive the plug of the electrical cord to selectively provide electrical power to the transmission coil; and/or the upstanding sidewall can include angled slots aligned across the bottom wall from one another and sized to receive the flange of the wall therein to hold the wall at an angle.

In accordance with another aspect, an induction charging apparatus for a portable electronic device is disclosed. The portable electronic device has a reception coil coupled to a power source and has an outwardly projecting attachment mounted thereon. The charging apparatus includes a housing defining an interior, an attachment device coupled to a rear of the housing that is configured to releasably secure the housing to a portion of a vehicle, and a mount of the housing has an open front and defines a recess sized to receive a portion of the attachment therein to secure the portable electronic device to the mount. The charging apparatus further includes a charging assembly disposed within the housing that includes a transmission coil having an annular configuration extending around the mount, such that the mount receiving the attachment therein sufficiently aligns the transmission coil with the reception coil to thereby charge the power source of the portable electronic device.

According to some forms, the charging apparatus can include one or more of the following aspects: the annular configuration can be a main surface of the transmission coil extending generally parallel with the open front of the mount; the annular configuration can be a cylindrical configuration extending away from the open front of the mount; the mount can include retention portions configured to grip the attachment to hold the attachment within the mount; the transmission coil can be spaced from a front surface of the mount (e.g., about 1 mm); the transmission coil can be mounted to an interior surface of a forward wall of the housing; the attachment device can be, e.g.: a vent attachment having a forked configuration, a suction cup, a wall portion having a tacky material disposed thereon, and/or the like; and/or the attachment device can further include an adjustable arm.

### BRIEF DESCRIPTION OF THE DRAWINGS

The accompanying appendices and/or drawings illustrate various non-limiting, example, innovative aspects in accordance with the present description:

FIG. 1 is a perspective view of an example induction charging device having a top wall with a recess therein in accordance with various embodiments;

FIG. 2A is a cross-sectional view of the induction charging device of FIG. 1;

FIG. 2B is a cross-sectional view of another example induction charging device in accordance with various embodiments;

FIG. 3 is an exploded view of an example induction charging device with a removable top wall in accordance with various embodiments;

FIG. 4 is a perspective view of the induction charging device of FIG. with the top wall in an upright configuration;

FIG. 5 is a cross-sectional view of the induction charging device of FIG. 3;

FIG. 6 is a perspective view of an example induction charging device configured for mounting, e.g., to a vehicle, in accordance with various embodiments;

FIG. 7 is a cross-sectional view of the induction charging device of FIG. 6;

FIG. 8 is a side elevational view of the induction charging device of FIG. 6 with a vent mount attachment;

FIG. 9 is a side elevational view of the induction charging device of FIG. 6 with a suction cup attachment;

FIG. 10 is a side elevational view of the induction charging device of FIG. 6 with a tacky attachment; and

FIG. 11 is a cross-sectional view of another example induction charging device in accordance with various embodiments.

### DETAILED DESCRIPTION

Many factors can influence the effectiveness of the energy transfer between an electronic device and a charging station, including material and space between the coils of the charging station and the electronic device. For example, covers, cases, devices, and accessories can increase the material and space between the coils of the charging station and the electronic device, as well as cause the electronic device to unstably rest on the charging station. Pursuant to various embodiments as discussed herein, induction charging apparatuses and methods are described that provide stable and effective charging of portable electronic devices having outwardly protruding attachments mounted thereto, such as grip attachments. In some implementations, the grip attachments can be expandable devices that include a base and an expanding mechanism that is movable relative to the base, e.g., between a collapsed configuration and an expanded configuration. The expandable devices may further include a button coupled to the expanding mechanism.

The embodiments described herein facilitate positioning and charging of the portable electronic devices by providing a recess, mount, and/or the like to receive the attachment therein. Further, the coil within the charging apparatus can be configured with an expanded range relative to conventional induction charging devices to transmit energy through the attachment and any cover on the portable electronic device. In some implementations, a user can adjust the portable electronic device within the recess to better align the coils for charging. In some implementations, the recess has a depth to fully receive the attachment therein so that the portable electronic device rests on the charging surface.

As shown in various ones of the figures, the induction charging devices and methods described herein are configured to charge a portable electronic device 10, such as a smart phone, tablet, e-reader, and/or the like. The portable electronic device 10 includes electronic components powered by a power source 12 and a coil 14 electrically coupled to the power source 12. The coil 14 may have a disk-shaped configuration with main surfaces 16 that extend in a direction generally parallel with respect to main surfaces 18 of the device 10. The device 10 can include a grip attachment 20 secured to a rear one of the main surfaces 18 or to a case 19 coupled to the device 10, e.g., to aid a user in holding and/or standing the device 10, as well as other functionalities. The grip attachment 20 can be an expandable grip accessory in the form of a commercially available grip and stand product. In such forms, the attachment 20 can have an expandable sidewall 22 with a button 24 coupled thereto. The sidewall 22 can be shifted between a collapsed, storage configuration as shown, and an expanded configuration for use.

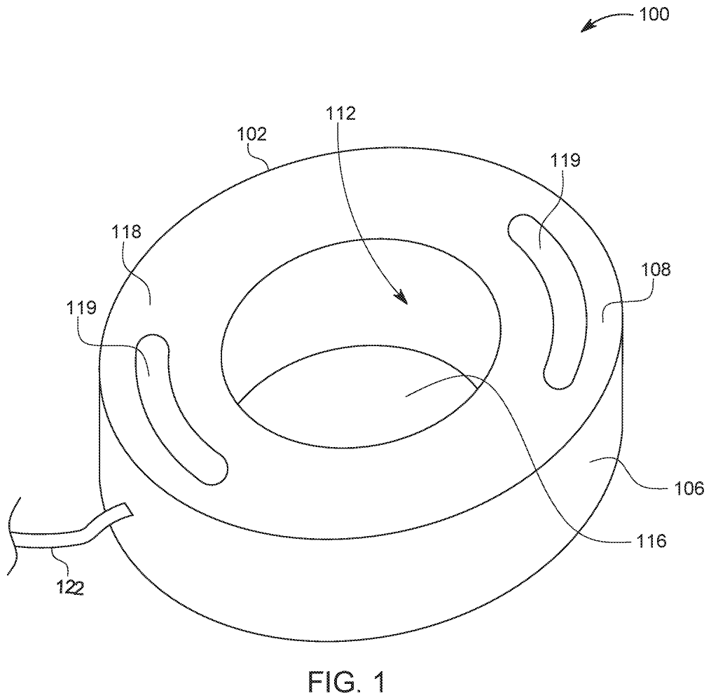

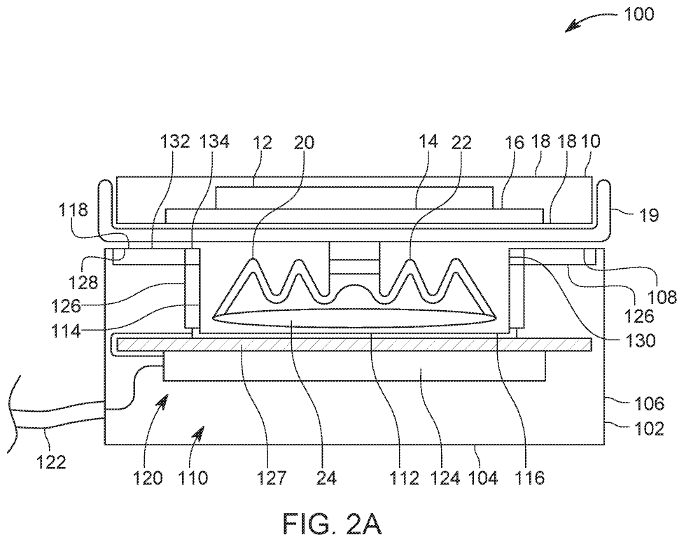

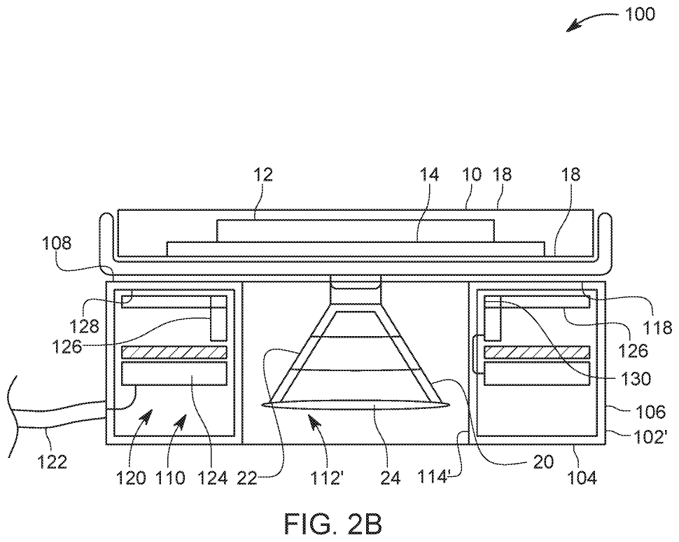

Some embodiments of an induction charging device 100 are shown in FIGS. 1 to 2B. The induction charging device 100 includes a housing 102 having a bottom wall 104, one or more upstanding sidewalls 106, and a top wall 108 defining an interior 110. As shown, the top wall 108 includes a recess 112 therein having a sidewall 114 and a bottom wall 116. In other implementations, the recess 112 may alternatively comprise tapering walls, steps, flexible or elastic walls, a plurality of sidewalls, and/or the like configured to accommodate the grip attachment 20 and/or portions thereof. The sidewall 114 can have an inwardly tapering configuration to aid a user in locating the recess 112 with the attachment 20 or can extend generally vertical with respect to the top wall 108. The top wall 108 provides a charging surface 118 for reception of the rear surface 18 of the portable electronic device 10 thereon during charging.

With this configuration, a user can place the electronic device 10 on the charging surface 118 with the attachment 20 aligned with the recess 112. In a first approach, the recess sidewall 114 is sized to give the recess 112 a depth sufficient to fully receive the attachment 20 therein so that the electronic device 10 stably rests on the charging surface 118. For example, the sidewall 114 can be sized to be substantially the same as a depth of the attachment 20 or can be larger than the attachment 20 so that the button 24 is spaced from the recess bottom wall 116 by a distance, such as about 1 to 3 mm. In a second approach, the sidewall 114 can be sized so that the attachment 20 rests on the bottom wall 116 causing the device 10 to be spaced from the charging surface 118. In another implementation, as shown in FIG. 2B, the housing 102′ can have an annular configuration with the recess 112′, and the sidewall 114′ thereof, extending an entire height of the housing 102′.

In some implementations, the charging surface 118 can include a tacky portion 119, which can extend across some, such as around the recess 112, 112′ or a perimeter of the charging surface 118, or all of the charging surface 118 and can be a layer, coating, member, and/or the like. The tacky portion 119 can be a suitable adhesive, including high and low tack adhesive, rubber, elastomers, and/or other polymers having sticky or tacky properties.

The recess 112, 112′ can have any suitable configuration. For example, the recess 112, 112′ can have a circular, oval, square, polygonal, and/or the like cross-section in a plane parallel to the charging surface 118. The cross-section can have a diameter or other dimension slightly larger, e.g., about 1 mm to 5 mm, than a largest diameter or dimension of the attachment 20 or can have an increased diameter with respect to the largest diameter or dimension of the attachment 20 so that a user can move the electronic device 10 around on the charging surface 118 to get better alignment as discussed in more detail below. For example, the diameter of the cross-section can be larger than the attachment 20 by 5 mm, 10 mm, 15 mm, 20 mm, 25 mm, 30 mm, and so forth. In another implementation, the cross-section of the recess 112, 112′ in the plane parallel to the charging surface 118 can have a track-shaped, elongate slot configuration so that a user can slide the electronic device 10 along the charging surface 118 with the attachment 20 sliding within the recess 112, 112′.

As shown in FIGS. 2A and 2B, the induction charging device 100 further includes an electronic assembly 120 having a power cord 122 configured to be coupled to a power source, such as an electrical wall outlet, a car outlet, a USB charging port, and/or the like, a printed circuit board assembly 124, and a transmission coil 126. The components of the electronic assembly 120 can be electrically coupled together by any of a variety of methods and/or mechanisms, including wires, traces, and/or the like. Further, in some implementations, the electronic assembly 120 can include shielding 127 disposed adjacent to the circuit board 124, such as to protect the circuit board 124 during use. For example, the shielding 127 can be disposed between the coil 126 and the circuit board 124 as shown and/or can be disposed below the circuit board 124 if components of the circuit board 124 are on the bottom thereof.

In some implementations, the recess 112, 112′ can be sized such that the device 10 can be charged whether the attachment 20 is in an expanded or collapsed state. Such implementations may be employed, for example, where the attachment 20 has metal components, such as in the button 24 thereof. For example, the recess 112, 112′ can be sized so that the metal components of the attachment 20 extend past the coil 126, such that the metal components do not interfere with the transfer of power from the coil 126 to the device 10.

As shown, implementations of the transmission coil 126 may have an annular configuration such as that extends around the recess sidewall 114, 114′ and may be adjacent to or abutting an interior surface 128 of the housing top wall 108. Alternatively, a diameter or dimension of the transmission coil 126 may be larger than a diameter or dimension of the recess. In one form, an interior edge 130 of the transmission coil 126 can have a diameter or dimension equal to or slightly, e.g., between about 1 mm to 5 mm or between about 1 mm to 3 mm, larger than an outer diameter of the recess sidewall 114, 114′ to account for the thickness thereof. In one implementation, the diameter or dimension of the transmission coil 126 is greater than 40 mm, greater than 42 mm, or in the range of 42 mm to 44 mm. In another implementation, the diameter or dimension of the transmission coil 126 is equal to or greater than about 50 mm. The top wall 108 can have a thickness of about 1 mm, or in a range of about 0.5 mm to about 3 mm or a range of about 1 mm to about 2 mm, such that the transmission coil 126 can be spaced from the charging surface 118 a similar, e.g., within 0, 0.1 mm, 0.2 mm, 0.3 mm, 0.4 mm, 0.5 mm, etc., distance as the thickness of the top wall 108. In charging the electronic device 10, a user may substantially align the coil 14 of the device 10 with the coil 126 of the charging device 100 to supply charging power to the power source 12.

As shown in FIGS. 2A and 2B, the annular configuration of the transmission coil 126 can, in some implementations, take a first or second form. In a first form, the transmission coil 126 has an annular discshape with main surfaces 132 that extend substantially parallel to the top wall 108. In this form, the interior edge 130 of the transmission coil 126 may be disposed adjacent to or abutting the recess sidewall 114, 114′ and the main surfaces 128 extend radially outward therefrom. In a second form, the transmission coil 126 can have a cylindrical annular configuration. In this form, a top edge 134 of the transmission coil 126 is disposed at or adjacent to the intersection of the recess sidewall 114, 114′ and the top wall 108 and the interior edge 130 is an interior surface that extends along, e.g., substantially parallel with respect to, the recess sidewall 114, 114′. The height and/or width of the annular transmission coil 126 can be any of a variety of dimensions, such as to provide a charging zone adjacent to the charging surface 118 of the top wall 108.

Although the recess 112, 112′ is shown as having a circular horizontal cross-section sized to receive an attachment 20 having a circular button 24, the recess 112, 112′ can have other shapes. For example, the recess 112, 112′ can have an oval or track-shaped horizontal cross-section to allow a user to move the attachment 20 within the recess 112, 112′ to better align the coils 14, 126. With such a configuration, the annular shape of the transmission coil 126 will be complementary to the shape of the recess 112, 112′. As discussed above, at least one dimension of the recess 112, 112′ in a plane parallel to the charging surface 118 can be larger than a corresponding dimension of the attachment 20 such that the electronic device 10 can be shifted on the charging surface 118 with the attachment 20 received within the recess 112, 112′ to refine the alignment of the transmission coil 126 with the reception coil 14.

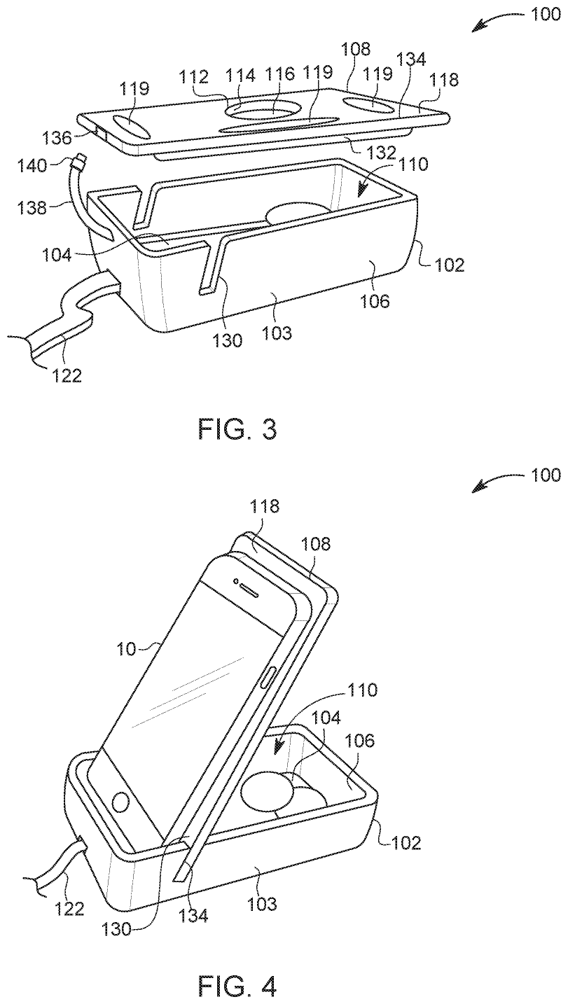

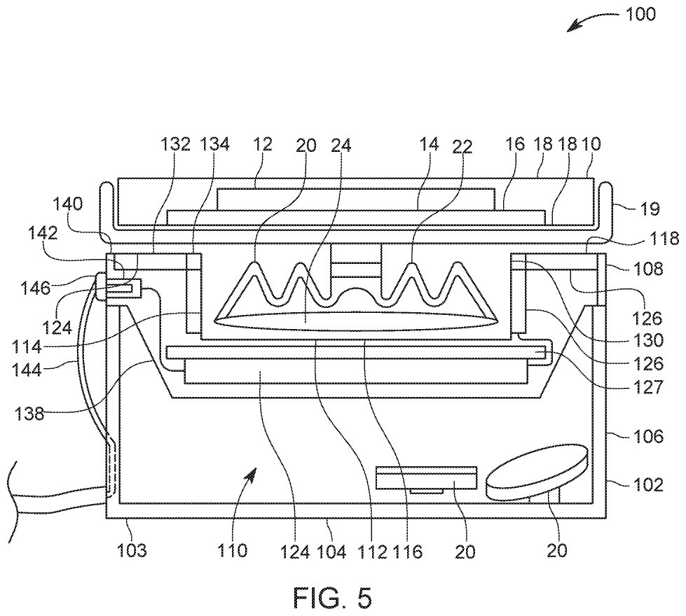

In a further form, the induction charging device 100, as shown in some implementations in FIGS. 3 to 5, the top wall 108 can rest on and be removable from the upstanding sidewalls 106. So configured, a user can carry the portable top wall 108 along with the electronic device 10 to charge the power source 12 remote from a base 103 that includes the sidewalls 106 and bottom wall 104. In some implementations, the base 103 can include slots 136 formed in the sidewalls 106 that are configured to receive the top wall 108 therein. As shown, the slots 136 may be aligned with one another across the bottom wall 104 and may extend at an angle with respect to horizontal so that, with the top wall 108 inserted into the slots 136, the top wall 108 is held at a convenient viewing angle. With the attachment 20 received within the recess 112, the top wall 108 can stably hold the electronic device 10 at the angle. In some implementations, the slots 130 can be disposed closely adjacent to the adjacent end wall 106 so that if the electronic device 10 slides on the charging surface 118, the device 10 can rest on the end wall 106.

In some implementations, the circuit board 124 and transmission coil 126 can be mounted within an enclosed housing portion 138 disposed around and/or below the recess 118. As shown, the coil 126 can be mounted to the interior surface 128 of the top wall 108 so that the coil 126 is positioned substantially adjacent to the charging surface 118 as described above. The enclosed housing portion 138 can protrude downwardly with respect to the charging surface 118 and be substantially centrally disposed on the top wall 108 and spaced from edges thereof, e.g., by a flange 140. In this form, the slots 136 in the sidewall 106 can have a width sized to receive the flange 140 therein to hold the top wall 108 at the angle.

In implementations, the top wall 108 can include an electrical port 142 and the electronic assembly 120 can further include a wire 144 with a plug 146 configured to be inserted into the port 142 to electrically couple the power cord 122 to components disposed within the enclosed housing portion 138 of the top wall 108. This arrangement can be utilized to electrically couple the circuit board 124 and coil 126 to the other components of the electronic assembly 120.

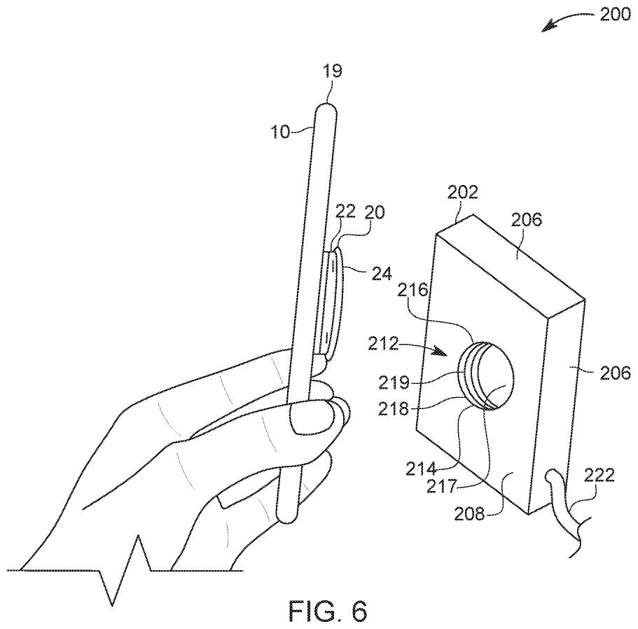

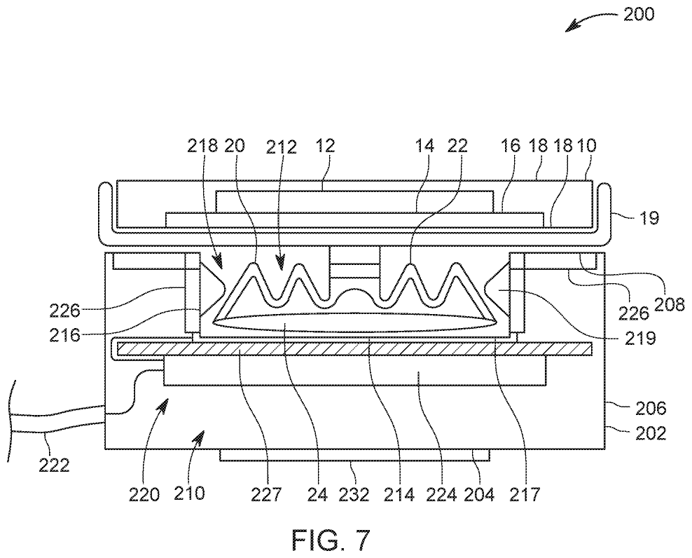

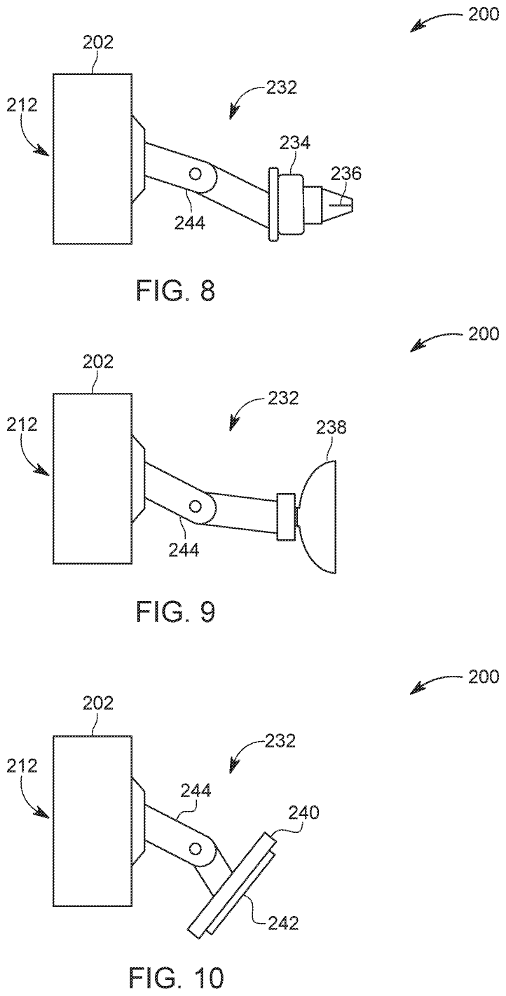

Another embodiment of an induction charging device 200 is shown in FIGS. 6-10 that may be employed, for example, for charging and holding the electronic device 10 in a vehicle or other mounted setting. The induction charging device 200 includes a housing 202 having a rear wall 204, one or more sidewalls 206, and a front wall 208 that define an interior 210. As shown, the front wall 208 of the housing 202 further includes a mount 212. The mount 212 includes a recess 214 having a sidewall 216, a bottom wall 217, and a forward opening 218. The recess 214 can be configured to retain the attachment 20 therein by any of a variety of methods and/or mechanisms. For example, the recess 214 can include resilient and/or deformable retaining portions or members 219 so that the attachment 20 can be slid behind the members 219 or be pushed through the members 219 so that the mount 212 retains the attachment 20. The members 219 can include tacky portions, which can extend across some or all of the exteriors thereof. The tacky portions can be layers, coatings, members, and/or the like, and can be an adhesive, including high and low tack adhesive, rubber, elastomers, other polymers, and/or the like having sticky and/or tacky properties. The recess 214 can have a circular cross-section as shown, a slot configuration, and/or other configurations. It will be understood moreover, that the mount 212 can have any suitable configuration to receive and retain attachments 20 having a variety of shapes and sizes, including but not limited to a circular button 24 with a frustoconical sidewall 22 as shown.

With this configuration, the button 24 of the attachment 20 can be slid or pushed into recess 21 to be retained by the members 219 and the collapsed depth of the body 22 of the attachment 20 can project through the forward opening 218. By retaining the attachment 20 within the mount 212, the charging device 200 effectively holds the electronic device 10 adjacent to the housing 202 closely adjacent to or abutting the front wall 208 thereof.

Similar to the above embodiments, the induction charging device 200 of this form further includes an electronic assembly 220 having a power cord 222 configured to be coupled to a power source, such as an electrical wall outlet, a car outlet, a USB charging port, and/or the like, a printed circuit board assembly 224, and a transmission coil 226. The components of the electronic assembly 220 can be electrically coupled together by any of a variety of methods and/or mechanisms, including wires, traces, and/or the like. The transmission coil 226 has an annular configuration extending around the recess 214 of the mount 212. In some implementations, the electronic assembly 220 can include shielding 227 disposed between the coil 226 and the circuit board 224, such as to protect the circuit board 224 during use. To charge the electronic device 10, a user may insert the attachment 20 into the mount 212 to substantially align the coil 14 of the device 10 with the coil 226 of the charging device 200 to supply charging power to the power source 12. In some implementations, the circuit board 224 and transmission coil 226 can be mounted within the housing interior 210 adjacent to or abutting an interior surface of the front wall 208 so that the coil 226 extends around the mount 312.

As discussed above, the annular configuration of the transmission coil 226 can take a first form having an annular disc-shape with main surfaces that extend substantially parallel to the front wall 208 and an interior edge that is disposed adjacent to or abutting the recess 214. In a second form, the transmission coil 226 can have a cylindrical annular configuration with a front edge disposed at or adjacent to the intersection of the recess 214 and the front wall 208 and an interior surface can extend along, e.g., substantially parallel with respect to, the recess sidewall 216. The height and/or width of the annular transmission coil 226 can be any of a variety of dimensions, such as to provide a charging zone adjacent to the front wall 208.

As discussed above, the charging device 200 can be secured to a portion of a vehicle in various implementations. For example, the charging device 200 can include an attachment device 232 secured or otherwise coupled to the rear and/or side wall 204, 206 of the housing 202. The attachment device 232 can take any of a variety of forms. For example, in a first form, the attachment device 232 can be a vent attachment 234 having a forked configuration with one or more slots 236 sized to receive a fan of a vehicle vent therein. In a second form, the attachment device 232 can be a suction cup 238 capable of being mounted to any suitable surface. In a third form, the attachment device 232 can be a planar or curved surface 240 having a tacky portion or portions 242, which can extend across some or all of the surface 240. The tacky portions 242 can be layers, coatings, members, etc., and can be an adhesive, including high and low tack adhesive, rubber, elastomers, other polymers, and/or the like having sticky and/or tacky properties. The tacky portions 242 can grip a surface of a vehicle to hold the electronic device 10 in various orientations and positions. In some implementations, the attachment device 232 of any of the above forms can further include an adjustable arm 244 having, e.g., hinged and/or pivoting portions allowing the position and orientation of the mount 212 with respect to a mounting surface on the vehicle to be varied.

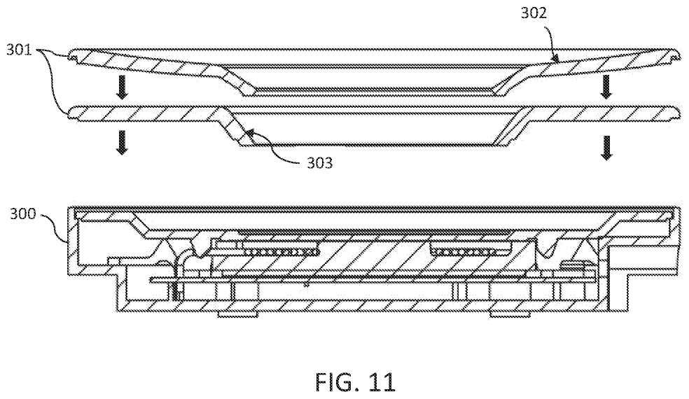

FIG. 11 is a cross-sectional view of another example of the charging device 100 or charging device 200 in which the housing of the device 100, 200 comprises a top cover 301 that is flat or formed and a base 300. Top cover 301 may be positioned over, and lowered onto, the base 300 (illustrated by downward arrows of FIG. 11) until the top cover 301 removably engages the base 300, such as through a press-fit, snap-fit, magnetic engagement, or other suitable engagement structure or means. Such removable engagement enables interchangeability of different shapes and forms of top cover 301, thereby enabling the charging device 100, 200 to accommodate portable electronic devices of varying shapes and forms.

Top cover 301 may further include protrusions or cavities 302, 303 forming mating features intended to improve coil alignment with respect to the aforementioned portable electronic devices. It should be appreciated such portable electronic device may include, but not be limited to, wireless chargeable headphone accessories, battery packs, mobile accessories, electronic mobile grip accessories, mobile devices with attachable accessories, and Bluetooth speakers.

It should also be appreciated that protrusions or cavities 302, 303 of top cover 301 may take a variety of forms, for example for the purpose of conforming to a receiving device shape or conforming to one or more features of a receiving portable electronic device. Moreover, top cover 301 may include interior openings or may comprise a surface without interior openings.

The top cover 301 may be comprised of a compound cavity with a first feature intended for device alignment and a second feature (an example of which is shown as 302) providing an air gap below a portable electronic device, such that the portable electronic device is thermally isolated, over a substantial portion of its charging surface, from top cover 301.

In various implementations, the coils discussed herein can be made of conductive material, such as a conductive metal. For example, in some implementations two layers of coil may be employed and/or the coil(s) may be surrounded by a ferrite layer or other ferrimagnetic ceramic material. Further, the charging devices 100, 200 can utilize any of a variety of standards, such as Qi, Magne Charge, Rezence, AirFuel Alliance, Power Matters Alliance (“PMA”), and/or the like. In some implementations, the coil(s) may effect and/or employ up to 15 watts of power, may conform to a power class 0 transmitter product type, and/or operate in a frequency range of about 110-205 kHz.

In some instances, the expandable grip accessory of the current disclosure may be in the form of a commercially available grip and stand product. For example, U.S. Pat. No. 8,560,031, filed on Feb. 23, 2012; U.S. Pat. No. 9,970,589, filed on Nov. 9, 2017; U.S. application Ser. No. 15/615,900, filed on Jun. 7, 2017; U.S. application Ser. No. 15/679,934, filed on Aug. 17, 2017; U.S. application Ser. No. 15/803,410, filed on Nov. 3, 2017; U.S. application Ser. No. 15/808,076, filed on Nov. 9, 2017; U.S. application Ser. No. 15/864,402, filed on Jan. 8, 2018; U.S. application Ser. No. 15/864,509, filed on Jan. 8, 2018; U.S. application Ser. No. 15/906,920, filed on Feb. 27, 2018; U.S. application Ser. No. 15/922,601, filed on Mar. 15, 2018; U.S. application Ser. No. 15/952,025, filed on Apr. 12, 2018; U.S. application Ser. No. 15/993,458, filed on May 30, 2018; and U.S. application Ser. No. 16/001,723, filed on Jun. 6, 2018 each describe suitable expandable grip and stand products, which also incorporate collapsible mechanisms, the entirety of each being hereby incorporated herein by reference. Moreover, aspects of the current disclosure may be incorporate, be incorporated within, or otherwise be compatible with the induction charging configurations described in PCT/IUS19/47401 filed Aug. 21, 2019, the entirety of which is hereby incorporated by reference.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. As used herein, the term “about” can be considered to encompass a range of 0.5 mm above and below the identified measurement. Also, common but well-understood elements that are useful or necessary in a commercially feasible embodiment are often not depicted in order to facilitate a less obstructed view of these various embodiments. The same reference numbers may be used to describe like or similar parts. Further, while several examples have been disclosed herein, any features from any examples may be combined with or replaced by other features from other examples. Moreover, while several examples have been disclosed herein, changes may be made to the disclosed examples within departing from the scope of the claims.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s).

1. An induction charging apparatus for a portable electronic device having a reception coil coupled to a power source and having an outwardly projecting attachment mounted thereon, the charging apparatus comprising:
a housing defining an interior and having a wall with an outwardly facing charging surface configured to receive the portable electronic device thereon for charging the power source thereof;
a recess in the wall sized to receive the attachment therein with the portable electronic device disposed on the charging surface;
a charging assembly disposed within the housing, the charging assembly including a transmission coil around the recess such that with the attachment received therein the transmission coil is sufficiently aligned with the reception coil to thereby charge the power source of the portable electronic device.

2. The charging apparatus of claim 1 wherein the transmission coil has an annular configuration.

3. The charging apparatus of claim 2, wherein the annular configuration of the transmission coil comprises a main surface of the transmission coil extending generally parallel with the outwardly facing charging surface.

4. The charging apparatus of claim 2, wherein the annular configuration of the transmission coil comprises a cylindrical configuration extending away from the wall.

5. The charging apparatus of claim 1, wherein the recess has a circular shaped cross-section in a plane parallel to the charging surface.

6. The charging apparatus of claim 1, wherein the recess includes a bottom wall and a depth of the recess between the charging surface and the bottom wall is sized to receive the attachment in the recess with the attachment spaced from the bottom wall.

7. The charging apparatus of claim 1, wherein the transmission coil is spaced from the charging surface about 1 mm.

8. The charging apparatus of claim 1, wherein an interior diameter of the transmission coil is greater than 40 mm.

9. The charging apparatus of claim 1, wherein the transmission coil is mounted to an interior surface of the wall.

10. The charging apparatus of claim 1, wherein the housing includes a base with a bottom wall and an upstanding sidewall; the wall includes an outwardly projecting flange configured to rest on the upstanding sidewall and is movable with respect to the base to access the interior of the housing; and the transmission coil is received within a housing portion coupled to the wall.

11. The charging apparatus of claim 10, wherein the charging assembly further comprises an electrical cord having a plug at a distal end coupled to the base and a port coupled to the wall and configured to receive the plug of the electrical cord to selectively provide electrical power to the transmission coil.

12. The charging apparatus of claim 10, wherein the upstanding sidewall includes angled slots aligned across the bottom wall from one another and sized to receive the flange of the wall therein to hold the wall at an angle.

13. The charging apparatus of claim 1, wherein the charging surface further comprises a tacky portion.

14. The charging apparatus of claim 1, wherein the housing comprises a top cover and a base, and wherein the top cover is configured to be removably engagable with the base.

15. An induction charging apparatus for a portable electronic device having a reception coil coupled to a power source and having an outwardly projecting attachment mounted thereon, the charging apparatus comprising:
a housing defining an interior;
an attachment device coupled to a rear of the housing, the attachment device configured to releasably secure the housing to a portion of a vehicle;
a mount of the housing, the mount having an open front and defining a recess sized to receive a portion of the attachment therein to secure the portable electronic device to the mount;
a charging assembly disposed within the housing, the charging assembly including a transmission coil around the mount, the mount receiving the attachment therein being configured to sufficiently align the transmission coil with the reception coil to thereby charge the power source of the portable electronic device.

16. The charging apparatus of claim 15, wherein the transmission coil has an annular configuration.

17. The charging apparatus of claim 16, wherein the annular configuration comprises a main surface of the transmission coil extending generally parallel with the open front of the mount.

18. The charging apparatus of claim 16, wherein the annular configuration comprises a cylindrical configuration extending away from the open front of the mount.

19. The charging apparatus of claim 15, wherein the mount includes retention portions configured to grip the attachment to hold the attachment within the mount.

20. The charging apparatus of claim 15, wherein the transmission coil is spaced from a front surface of the mount about 1 mm.

21. The charging apparatus of claim 15, wherein the transmission coil is mounted to an interior surface of a forward wall of the housing.

22. The charging apparatus of claim 15, wherein the attachment device comprises one of: a vent attachment having a forked configuration; a suction cup; or a wall portion having a tacky material disposed thereon.

23. The charging apparatus of claim 15, wherein the attachment device further comprises an adjustable arm.

24. The charging apparatus of claim 15, wherein the housing comprises a top cover and a base, and wherein the top cover is configured to be removably engagable with the base.
